(19) United States
(12) Patent Application Publication
(10) Pub. No.: US 2013/0189471 A1
(43) Pub. Date: Jul. 25, 2013

(54) FIRE RESISTANT INSULATED FLEXIBLE WALL PANELS

(71) Applicants: Charles J. Ashelin, Dubuque, IA (US); David J. Hoffmann, Peosta, IA (US)

(72) Inventors: Charles J. Ashelin, Dubuque, IA (US); David J. Hoffmann, Peosta, IA (US)

(21) Appl. No.: 13/357,288

(22) Filed: Jan. 24, 2012

(51) Int. Cl. E04B 2/74; E04B 1/94; B32B 3/02; B32B 7/02

(52) U.S. Cl. 428/76; 428/213; 428/212

(57) ABSTRACT

Example flexible wall panels (e.g., demising walls) comprising a flexible, thermally insulated multilayer panel with a flammable core has a surprisingly low flame-spread index and smoke-developed index due to the flammable core being sandwiched between two fire resistant pads. The flammable core's high thermal resistance (high R-value) provides most of the panel's thermal insulation while a peripheral compressed region and the fire resistant pads help keep the flammable core from burning. In some examples, the materials and thicknesses of the panel's core, fire resistant pads and surrounding outer skin are such that the panel is of sufficient flexibility to be folded onto itself without experiencing appreciable permanent damage.

### FIELD OF THE DISCLOSURE

This patent generally pertains to flexible wall panels and, more specifically, to fire resistant insulated flexible wall panels.

### BACKGROUND

A demising wall is an interior wall, curtain or panel often used for dividing one leased portion of a building from another. Although such demising walls may not be as permanent as the building's exterior walls, demising walls preferably are sturdy for security, fire resistant for safety, and lightweight and flexible for versatile configurability. The term, “fire resistance” is a measure of a material's ability to resist or delay burning.

Flame-spread index and smoke-developed index are related to fire resistance in that the indices are quantitative values representative of a structure's tendency to promote flames and smoke, respectively. Flame-spread and smoke-developed indices, as referenced herein, are defined by a conventional standard test known as ASTM E84-11a (as it existed on Sep. 26, 2011). The ASTM E84-11a test standard, also known as Test for Surface Burning Characteristics of Building Material is provided by the American Society for Testing and Materials and is further published under UL 723, UBC 8-1, and NFPA 255. The test, for example, basically involves exposing a test specimen of a given nominal size to a flaming fire in a 25-foot tunnel The resulting propagation of flame and smoke from the test specimen is compared to that resulting from similar shaped specimens of mineral fiber cement board and select grade red oak flooring.

In some situations, a demising wall may be insulated for thermal resistance. The term, “thermal resistance” is an inverse measure of a structure's ability to conduct heat. Thermal resistance, as used herein, is in terms of R-value, which is the temperature differential (degrees-Fahrenheit) across a generally planar structure divided by the heat flux (Btu/hr per square-foot) through the structure. The heat flux is the heat transfer per unit area of a generally planar surface of the structure, wherein the heat transfer is in a direction perpendicular to the structure's planar surface. Thermal resistance and R-values as used herein are in units of (degree-Fahrenheit)/(Btu/hr per square-foot).

### BRIEF DESCRIPTION OF THE DRAWINGS

FIG. 1 is a perspective view of an example fire resistant flexible wall panel constructed in accordance with the teachings of this disclosure.

FIG. 2 is an exploded view of the flexible wall panel shown in FIG. 1.

FIG. 3 is a cross-sectional view taken along line 3-3 of FIG. 1.

FIG. 4 is a cross-sectional view similar to FIG. 3 but showing another example flexible wall panel having multilayer core.

FIG. 5 is a cross-sectional view taken along line 5-5 of FIG. 1.

FIG. 6 is a perspective view showing another example flexible wall panel suspended from an overhead support.

FIG. 7 is a perspective view showing an example flexible wall panel being used as a door.

FIG. 8 is a perspective view showing a plurality of example flexible wall panels interconnected to provide a wall panel assembly.

FIG. 9 is a perspective view showing the flexibility of an example flexible wall panel.

### DETAILED DESCRIPTION

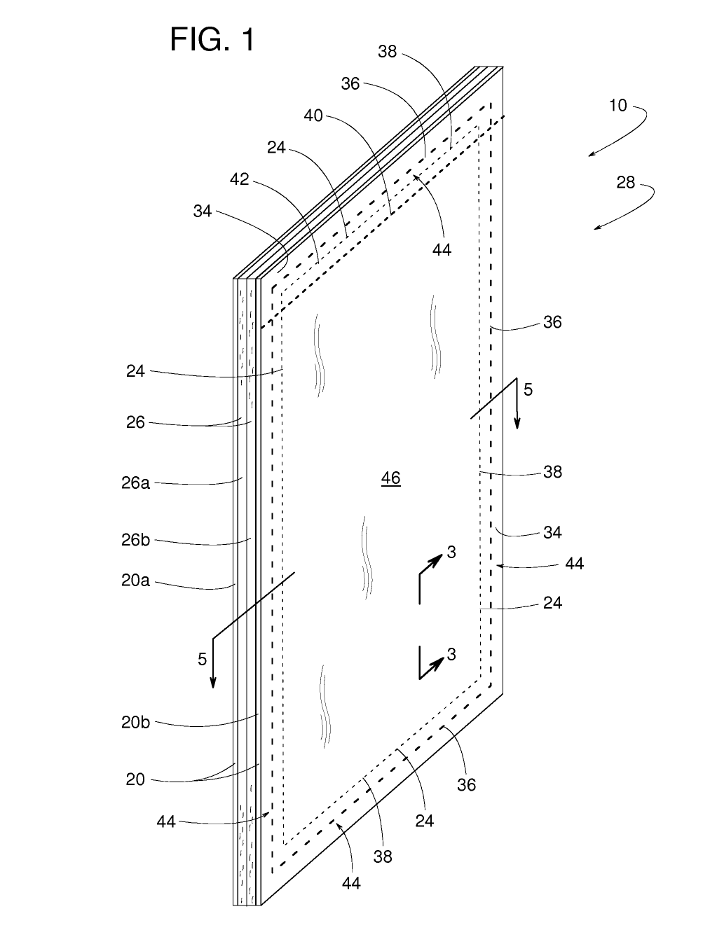

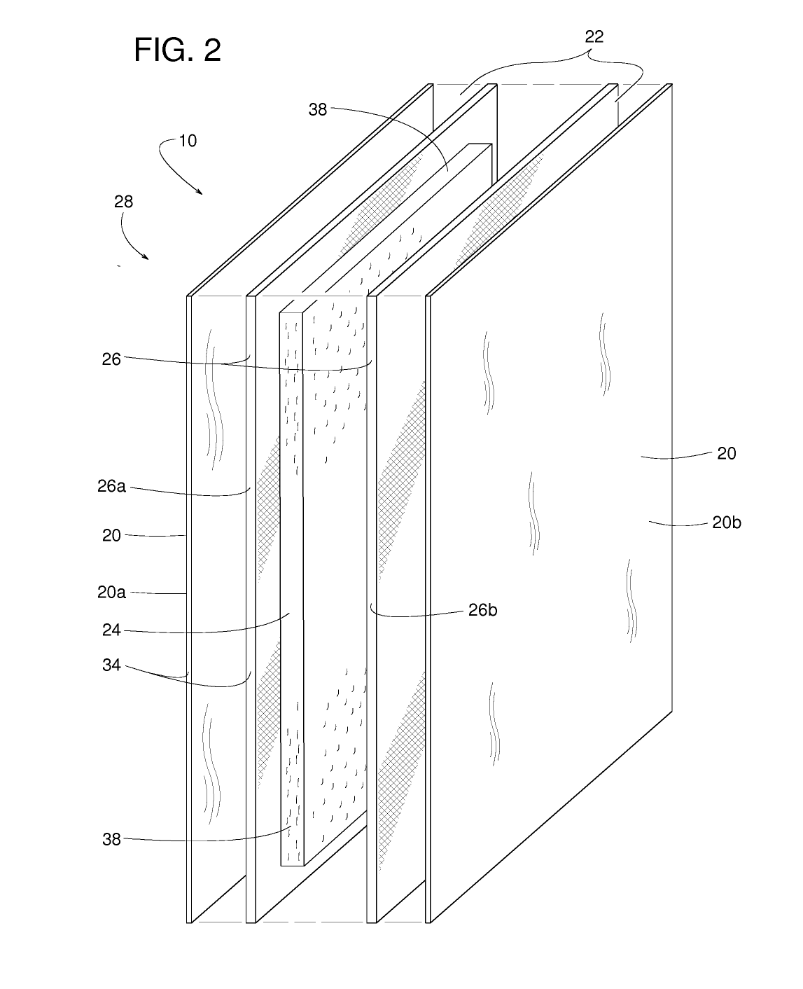

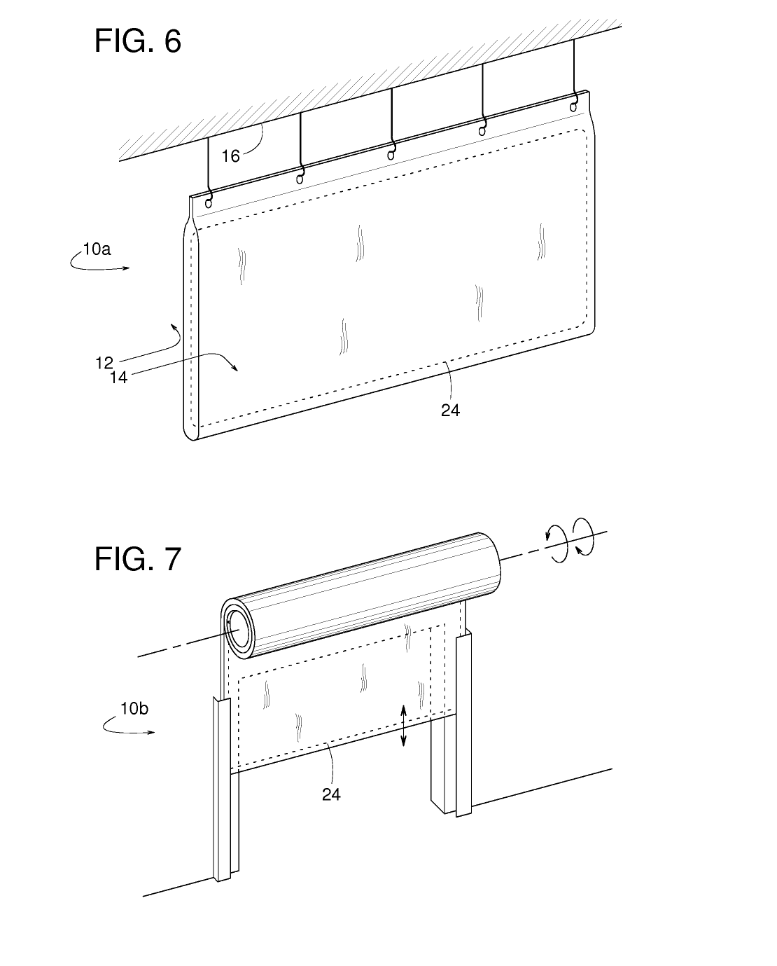

FIGS. 1-9 illustrate example fire resistive flexible wall panels 10 and various portions, features and/or variations thereof. FIGS. 1-5, for example, show the flexible wall panel 10 having a multilayer construction. Some examples of flexible wall panel 10 (e.g., flexible wall panels 10a, 10b and 10c of FIGS. 6, 7 and 8, respectively) are particularly useful as a demising wall for separating two adjacent building spaces 12 and 14. The term, “building space” means any area associated with a building. Examples of a building space include, but are not limited to, a room, a hallway, a cold storage compartment, any area inside of a building (e.g., an area enclosing machinery or equipment), an area just outside of a building, a loading dock (interior side and exterior side), etc.

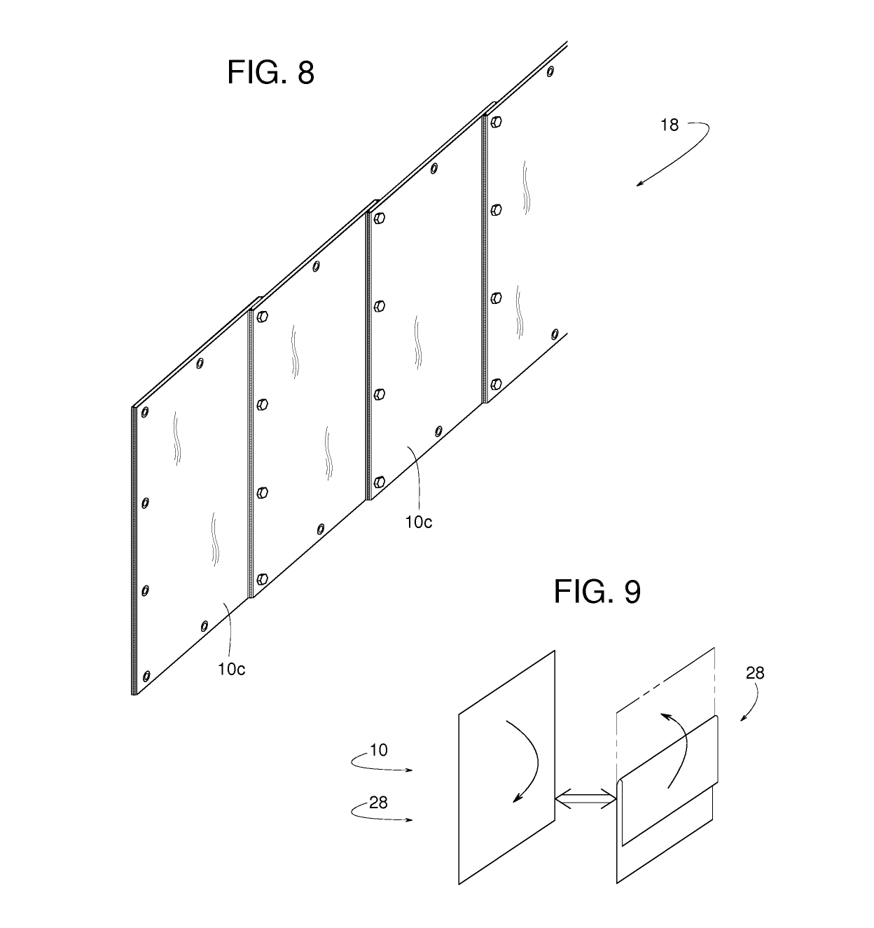

As for example uses and configurations of wall panel 10, FIG. 6 shows flexible wall panel 10a suspended from an overhead support 16 (e.g., ceiling, beam, rafter, joist, truss, cable, etc.). FIG. 7 shows flexible wall panel 10b being used as a door (e.g., a rollup door, vertically moving door, folding door, horizontally translating door, etc.). FIG. 8 shows a plurality of flexible wall panels 10c interconnected to create a larger wall panel assembly 18.

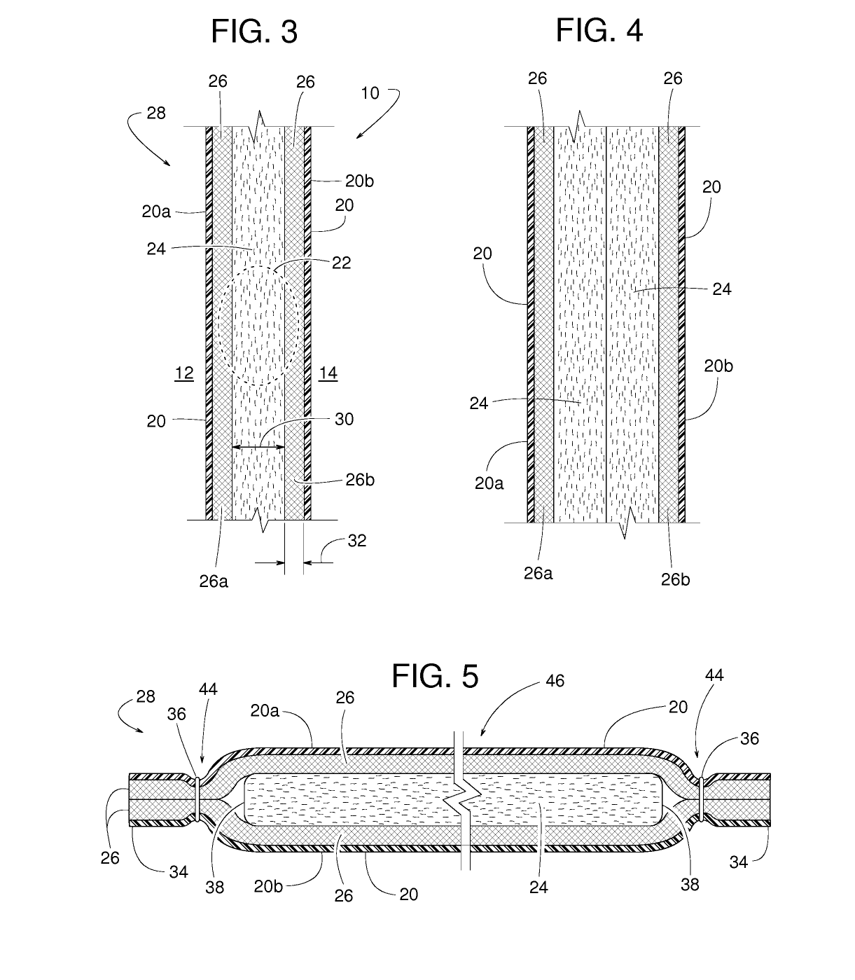

Referring to FIGS. 1-5, to provide flexible wall panel 10 with a combination of sturdiness, fire resistance, lightweight construction, flexibility and high thermal resistance, some examples of flexible wall panel 10 have a pliable outer skin 20 (a first skin 20a and a second skin 20b) containing a multilayer portion 22 (FIG. 3). Some examples of multilayer portion 22 comprise a flexible core 24 positioned or disposed (e.g., sandwiched) between flexible pads 26 (e.g., a first pad 26a and a second pad 26b). A combination of multilayer portion 22 and outer skin 20 will be referred to herein as a panel assembly 28.

To provide panel assembly 28 with relatively high thermal resistance and lightweight construction, some examples of core 24 include, but are not limited to, rayon fiber batting, polyester fiber batting and polyethylene bubble pack (with or without foil). In some examples, core 24 has a thickness 30 of about 0.75 inches and a thermal resistance of about R-3. In some examples, core 24 includes two or more layers. For example, in the illustrated example of FIG. 4, core 24 includes two 0.75-inch layers to provide a core 24 having a total dimensional thickness of about 1.5 inches and a thermal resistance of about R-6.

However, some such core materials have a relatively low fire resistance rating. To protect core 24 and improve the panel assembly's overall fire resistance, flame-spread index and/or smoke-developed index, core 24 is positioned or disposed (e.g., sandwiched) between pads 26, which have a greater fire resistance (e.g., a higher rating) than core 24. Even though core 24 is relatively flammable, pads 26 tend to resist and/or snuff out combustion that might otherwise quickly spread through core 24. Some examples of pad 26 include, but are not limited to, carbon fiber batting, fiberglass cloth, reinforced aluminum foil, rock wool batting and ceramic fiber batting. In examples where core 24 is made of 0.75-inch thick rayon fiber batting, positive results have been achieved with each pad 26 being made of carbon fiber batting having a thickness 32 of approximately 0.25 inches. Although some examples of pads 26 have a thermal resistance of less than 0.5-R, the core's relatively high thermal resistance compensates for that.

Outer skin 20 helps hold multilayer portion 22 together to complete panel assembly 28. Some examples of outer skin 20 include, but are not limited to, polyester fabric, PVC coated polyester, silicone rubber coated fiberglass cloth, and aluminized fiberglass cloth. Some examples of outer skin 20 also include a known fire retardant to suppress, reduce and/or delay combustion of skin 20. Some examples of skin 20 are about 0.015 inches thick with less thermal resistance than that of core 24 and pad 26.

In some examples, skin 20 and pads 26 are coupled together via fasteners. In the illustrated example of FIGS. 1-5, skin 20 and pads 26 are sewn together proximate their outer perimeters (panel perimeter 34) via a plurality of stitches 36 of fire resistant thread. Stitches 36 are beyond a core perimeter 38 of core 24 to avoid exposing and burning the core's outer edges when wall panel 10 is exposed to extreme heat. Stitches 36 provide panel 28 with a compressed region 44 encircling at least most of core perimeter 38 to help protect core 24 from burning. Panel perimeter 34 encircles peripheral compressed region 44, wherein peripheral compressed region 44 runs along stitches 36. Compressed region 44 is such that a central region 46 of panel assembly 28 is thicker and has greater thermal resistance than compressed region 44. In some examples, panel perimeter 34 is thicker and has greater thermal resistance than compressed region 44. In some examples, central region 46 is thicker and has greater thermal resistance than panel perimeter 34. In some examples, to hold core 24 in position, an upper run of stitches 40 may be employed to fasten an upper edge 42 of core 24 to both pad 26 and outer skin 20.

In some examples, grommets, snaps, clips, laces, zippers, seals, connecters, tongue-in-groove joints, hook-and-loop joints, and/or additional features and elements are added to panel assembly 28 to facilitate various divider uses, such as those shown in FIGS. 6-8. In some examples, the materials and thicknesses of core 24, pad 26 and/or skin 20 are such that panel assembly 28 is of sufficient flexibility to be folded onto itself, as shown in FIG. 9, without panel assembly 28 experiencing appreciable permanent damage and/or permanent deformation. Except in the area of compressed region 44, a material's fire resistance, thickness and/or thermal resistance, when specified herein, pertain to the material in its relaxed, generally uncompressed state. In some examples, skins 20a and 20b are a single sheet folded in half. In some examples, pads 26a and 26b are a single pad folded in half. Some examples of flexible wall panel 10 have a flame-spread index of less than than 26 and a smoke-developed index of less than 251. In some examples, flexible wall panel 10 has a flame-spread index of 25 and a smoke-developed index of 125.

Although certain example methods, apparatus and articles of manufacture have been described herein, the scope of the coverage of this patent is not limited thereto. On the contrary, this patent covers all methods, apparatus and articles of manufacture fairly falling within the scope of the appended claims either literally or under the doctrine of equivalents.

1. A fire resistive flexible wall panel comprising:
a first pad;
a second pad;
a core positioned between the first and second pads, the core having a greater thermal resistance than each of the first and second pads, the first and second pads having greater fire resistance than the core; and
an outer skin containing the core and the first and second pads, the outer skin being thinner than the core, the outer skin being thinner than the first and second pads.

2. The fire resistive flexible wall panel of claim 1, wherein the core, the first and second pads and the outer skin provide a panel assembly, the panel assembly having sufficient flexibility to be folded onto itself without the panel assembly experiencing appreciable permanent damage.

3. The fire resistive flexible wall panel of claim 1, wherein the first and second pads are in contact with the outer skin and the core.

4. The fire resistive flexible wall panel of claim 1, wherein the core, the first and second pads and the outer skin provide a panel assembly, the panel assembly having a flame-spread index of less than 26 and a smoke-developed index of less than 251, the smoke-developed index and the flame-spread index being as defined via a test standard ASTM E84-11a as the test standard ASTM E84-11a existed on Sep. 26, 2011.

5. The fire resistive flexible wall panel of claim 1, wherein the core is thicker than each of the first and second pads.

6. The fire resistive flexible wall panel of claim 1, wherein the core, the first and second pads and the outer skin provide a panel assembly, the panel assembly to be suspended between two building spaces.

7. A fire resistive flexible wall panel comprising:
a first pad;
a second pad;
a core sandwiched between the first pad and the second pad;
an outer skin containing the first pad, the second pad and the core; and
a panel assembly comprising the first pad, the second pad, the core and the outer skin, the panel assembly having sufficient flexibility to be folded onto itself without the panel assembly experiencing appreciable permanent damage, the panel assembly having a flame-spread index of less than 26 and a smoke-developed index of less than 251, the smoke-developed index and the flame-spread index being as defined via a test standard ASTM E84-11a as the test standard ASTM E84-11a existed on Sep. 26, 2011.

8. The fire resistive flexible wall panel of claim 7, wherein the core is thicker than each of the first pad and the second pad, the skin is thinner than the core, and the skin is thinner than each of the first pad and the second pad.

9. The fire resistive flexible wall panel of claim 7, wherein the first pad and the second pad have greater fire resistance than the core.

10. The fire resistive flexible wall panel of claim 7, wherein the first pad and the second pad have greater fire resistance than the outer skin.

11. The fire resistive flexible wall panel of claim 7, wherein the core has a greater thermal resistance than each of the first pad and the second pad.

12. The fire resistive flexible wall panel of claim 11, wherein the first pad and the second pad each have a greater thermal resistance than the outer skin.

13. The fire resistive flexible wall panel of claim 7, wherein the first pad and the second pad are in contact with the outer skin and the core.

14. The fire resistive flexible wall panel of claim 7, wherein the core, the first pad, the second pad, and the outer skin provide a panel assembly, and the panel assembly is to be suspended between two adjacent building spaces.

15. A fire resistive flexible wall panel comprising:
a first pad having a first pad thickness, a first pad thermal resistance, and a first pad fire resistance;
a second pad having a second pad thickness, a second pad thermal resistance, and a second pad fire resistance;
a core sandwiched between the first pad and the second pad, the core having a core thickness, a core thermal resistance and a core fire resistance;
a first skin having a first skin thickness, a first skin thermal resistance, and a first skin fire resistance;
a second skin having a second skin thickness, a second skin thermal resistance, and a second skin fire resistance; and
a multilayer portion comprising the core, the first pad and the second pad; the multilayer portion being sandwiched between the first skin and the second skin;
a) the core having a dimensional thickness greater than the first pad thickness,
b) the first pad having a dimensional thickness greater than the first skin thickness,
c) the core thermal resistance being greater than the first pad thermal resistance,
d) the first pad thermal resistance being greater than the first skin thermal resistance,
e) the first pad fire resistance being greater than the core fire resistance, and
f) the first skin fire resistance being greater than the core fire resistance.

16. The fire resistive flexible wall panel of claim 15, wherein the first pad is in contact with the first skin and the core, and the second pad is in contact with the second skin and the core.

17. The fire resistive flexible wall panel of claim 15, wherein the first skin, the second skin and the multilayer portion provide a panel assembly, and the panel assembly has a flame-spread index of less than 26 and a smoke-developed index of less than 251, the smoke-developed index and the flame-spread index being as defined via a test standard ASTM E84-11a as the test standard ASTM E84-11a existed on Sep. 26, 2011.

18. The fire resistive flexible wall panel of claim 15, wherein the first skin, the second skin and the multilayer portion provide a panel assembly, and the panel assembly having sufficient flexibility to be folded onto itself without the panel assembly experiencing appreciable permanent damage.

19. The fire resistive flexible wall panel of claim 15, wherein the first skin, the second skin and the multilayer portion provide a panel assembly, and the panel assembly is to be suspended between two adjacent building spaces.

20. The fire resistive flexible wall panel of claim 15, wherein first pad thickness, the first pad thermal resistance and the first pad fire resistance is substantially equal to the second pad thickness, the second pad thermal resistance and the second pad fire resistance, respectively.

21. The fire resistive flexible wall panel of claim 15, wherein the first skin thickness, the first skin thermal resistance and the first skin fire resistance is substantially equal to the second skin thickness, the second skin thermal resistance and the second skin fire resistance, respectively.

22. A fire resistive flexible wall panel comprising:
two pads;
a core sandwiched between the two pads, the core having a core perimeter;
an outer skin containing the two pads and the core;
a panel assembly comprising the two pads, the core and the outer skin;
a panel perimeter defined by at least one of the outer skin and the two pads;
a central region of the panel assembly, the central region being centrally located within the panel perimeter; and
a peripheral compressed region defined by the panel assembly, the peripheral compressed region encircling most of the core perimeter, the panel perimeter encircling most of the compressed region, the panel assembly being thicker at the panel perimeter than at the compressed region.

23. The fire resistive flexible wall panel of claim 22, wherein the panel assembly is thicker at the central region than at the peripheral compressed region.

24. The fire resistive flexible wall panel of claim 22, wherein the panel assembly is thicker at the central region than at the panel perimeter.

25. The fire resistive flexible wall panel of claim 22, wherein the panel assembly has greater thermal resistance at the central region than at the peripheral compressed region.

26. The fire resistive flexible wall panel of claim 22, wherein the panel assembly has greater thermal resistance at the panel perimeter than at the peripheral compressed region.

27. The fire resistive flexible wall panel of claim 22, further comprising a plurality of stitches disposed along the peripheral compressed region.
